(19) United States
(12) Patent Application Publication
(10) Pub. No.: US 2011/0238686 A1
(43) Pub. Date: Sep. 29, 2011

(54) CACHING DATA OBTAINED VIA DATA SERVICE INTERFACES

(75) Inventors: Thomas Frank Bergstraesser, Kirkland, WA (US); Tai-Yi Huang, Bellevue, WA (US); Bo-June Hsu, Woodinville, WA (US); Bert Casper, Redmond, WA (US)

(73) Assignee: MICROSOFT CORPORATION, Redmond, WA (US)

(21) Appl. No.: 12/730,748

(22) Filed: Mar. 24, 2010

(51) Int. Cl. G06F 17/30; G06F 9/54

(52) U.S. Cl. 707/769; 719/328; 707/E17.014

(57) ABSTRACT

A potential user query that can be subsequently received from a user is identified. An interface exposed by a data service is invoked, which includes providing the potential user query to the interface. Search results in response to the potential user query are received from the interface and maintained in a complex data set store. If a user query is subsequently received that maps to a normalized query that is the potential user query, then search results for the normalized query are obtained from the complex data set store and returned as the search results for the user query.

### BACKGROUND

Large amounts of information are available to users via various networks, such as via the Internet and the World Wide Web (or simply the Web). Given the large amounts of information available to users, search engines have been developed that allow users to search for the information they desire. These search engines typically rely on techniques that involve accessing HyperText Markup Language (HTML) Web pages via the Internet. However, such techniques can be problematic because some information available via the Internet is not stored in HTML Web pages. Accordingly, traditional search engines may miss such information, which leads to the search engines returning poor search results.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a potential user query that can be subsequently received from a requester is identified. An interface exposed by a data service is invoked, which includes providing the potential user query to the interface of the data service. Search results in response to the potential user query are received from the interface of the data service, and maintained in a complex data set store from which the search results can be returned if the potential user query is subsequently received.

In accordance with one or more aspects, a user query is received and mapped to a normalized query. Search results for the normalized query are obtained from a complex data set store. The search results are in the complex data set store as a result of the normalized query having been submitted, prior to receiving the user query, to an interface of a data service. The search results for the normalized query, from the complex data set store, are returned as the search results for the user query.

### BRIEF DESCRIPTION OF THE DRAWINGS

The same numbers are used throughout the drawings to reference like features.

FIG. 1 illustrates an example system implementing the caching data obtained via data service interfaces in accordance with one or more embodiments.

FIG. 2 illustrates a system including a search service implementing the caching data obtained via data service interfaces in additional detail in accordance with one or more embodiments.

FIG. 3 is a flowchart illustrating an example process for caching data obtained via data service interfaces in accordance with one or more embodiments.

FIG. 4 is a flowchart illustrating an example process for retrieving previously cached data in response to a user query in accordance with one or more embodiments.

FIG. 5 illustrates an example computing device that can be configured to implement the caching data obtained via data service interfaces in accordance with one or more embodiments.

### DETAILED DESCRIPTION

Caching data obtained via data service interfaces is discussed herein. A complex data set store is generated that caches search results obtained from one or more data services. The search results are obtained by providing a potential user query to an interface of a data service, and the search results returned by the data service are maintained in the complex data set store as being associated with the potential user query. The search results are obtained based on potential user queries that may be subsequently submitted by a user, but the search results are obtained independently of whether any particular user query is actually received. If the potential user query is subsequently received, then the previously obtained search results cached in the complex data set store are returned in response to the user query. The interface of the data service need not be accessed in response to the subsequently received query because the search results to be returned in response to the query are already stored in the complex data set store.

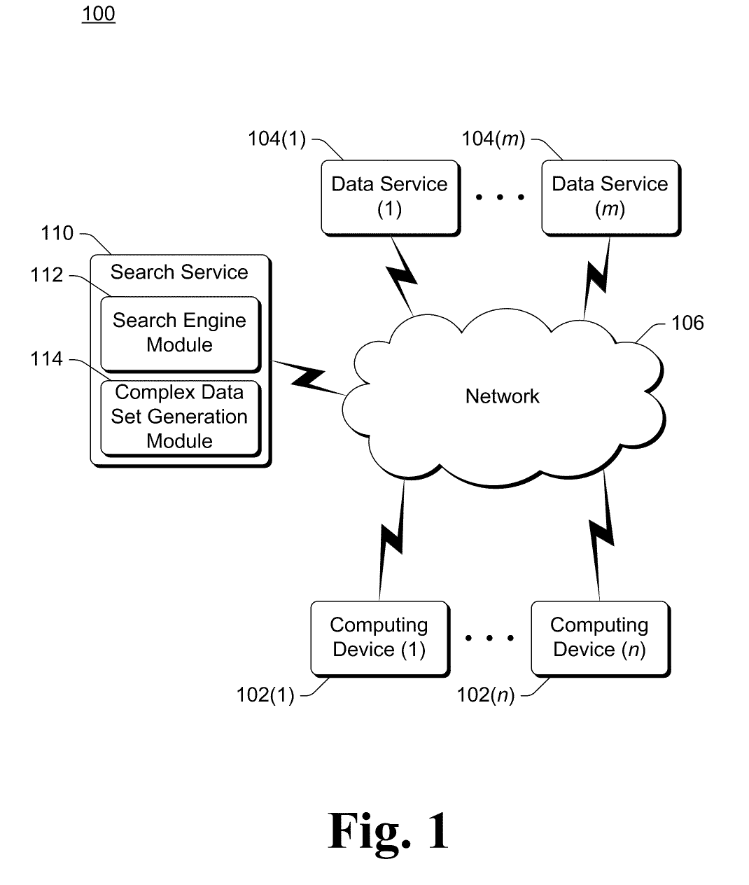

FIG. 1 illustrates an example system 100 implementing the caching data obtained via data service interfaces in accordance with one or more embodiments. System 100 includes one or more (n) computing devices 102(1), . . . , 102(n) that can communicate with one or more (m) data services 104(1), . . . , 104(m) via a network 106. Network 106 can be a variety of different types of networks, including the Internet, a local area network (LAN), a cellular or other phone network, an intranet, other public and/or proprietary networks, combinations thereof, and so forth.

Each computing device 102 can be a variety of different types of devices. For example, a computing device 102 can be a desktop computer, a mobile station, an entertainment appliance, a set-top box communicatively coupled to a display device, a cellular or other wireless phone, a game console, an automotive computer, and so forth. Thus, each computing device 102 may range from a full resource device with substantial memory and processor resources (e.g., personal computers, game consoles) to a low-resource device with limited memory and/or processing resources (e.g., traditional set-top boxes, hand-held game consoles). Different computing devices 102 can be the same type of device or alternatively different types of devices.

Data services 104 are implemented using one or more computing devices that receive requests for data and respond to those requests. Rather than simply hosting Web pages that can be retrieved and displayed by a computing device 102, data services 104 expose an interface that can be invoked by computing devices 102 to request data. Similar to the discussion of computing device 102, each data service 104 can be implemented using a variety of different types of devices, ranging from full resource devices with substantial memory and processor resources to low-resource device with limited memory and/or processing resources. Different data services 104 can be implemented using the same types of devices or alternatively different types of devices.

Computing devices 102 and data services 104 can also communicate with search service 110 via network 106. Search service 110 can be implemented using one or more computing devices. Similar to the discussion of computing device 102, search service 110 can be implemented using a variety of different types of devices, ranging from full resource devices with substantial memory and processor resources to low-resource devices with limited memory and/or processing resources.

Generally, search service 110 receives user queries from computing devices 102 and returns search results in response to those user queries. Search service 110 includes a search engine module 112 and a complex data set generation module 114. Complex data set generation module 114 maintains a complex data set store that caches search results received in response to potential user queries that module 114 sends to data services 104. Complex data set generation module 114 sends potential user queries to data services 104 independently of whether any such user queries are actually submitted to search service 110 by a user of a computing device 102. When a user query is subsequently submitted by a user of a computing device 102, search engine module 112 receives the user query and accesses the complex data set store maintained by module 114. The search results previously obtained by complex data set generation module 114 and stored in the complex data set store are retrieved by search engine module 112 and returned as at least part of the response to the user query. Search results obtained from data services 104 based on a potential query are thus obtained by search service 110 before the actual query is received from a computing device 102. Therefore, search service 110 need not incur the time expense of accessing data service 104 in response to the actual query being received from a computing device 102.

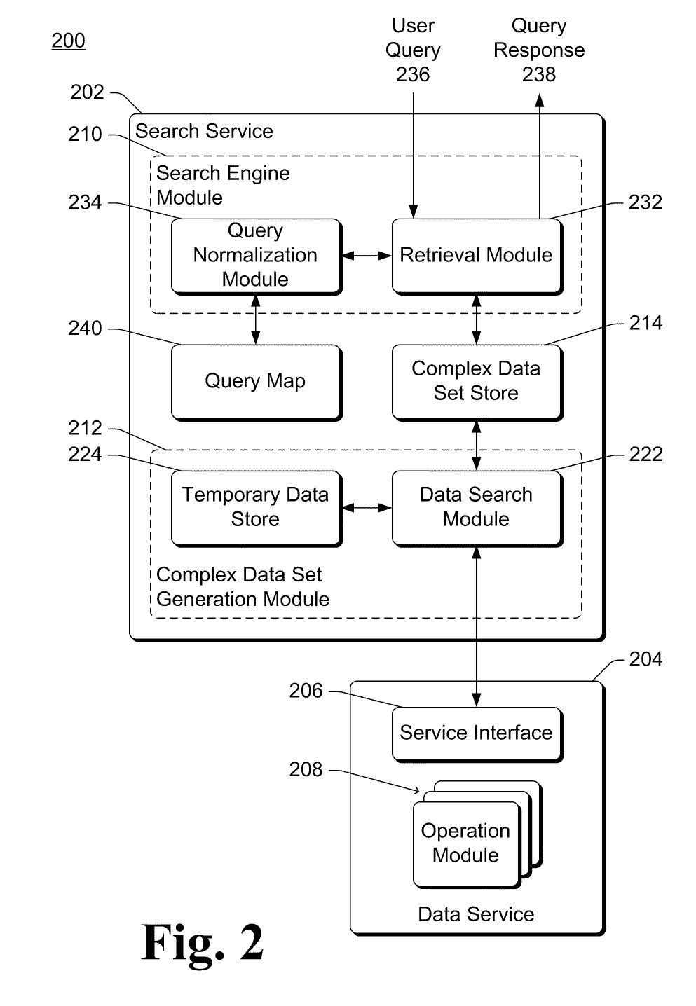

FIG. 2 illustrates a system 200 including a search service implementing the caching data obtained via data service interfaces in additional detail in accordance with one or more embodiments. System 200 includes a search service 202 and a data service 204. Search service 202 can be, for example, search service 110 of FIG. 1. Data service 204 can be, for example, a data service 104 of FIG. 1.

Data service 204 includes a service interface 206 and one or more operation modules 208. Service interface 206 is an interface that is exposed to and can be invoked by different computing devices or services, such as search service 202. Search interface 206 can be, for example, an Application Programming Interface (API). Operation modules 208 provide the functionality of data service 204. A variety of different functionality can be provided by operation modules 208, such as searching data stores local to data service 204, searching data stores remote from data service 204, performing one or more calculations based on stored or received data, and so forth. A single data service 204 is illustrated in FIG. 2, but it is to be appreciated that search service 202 can communicate with multiple data services 204.

Data service 204 maintains structured data. This structured data can be data that is maintained in a database or other store and is accessed or operated on in response to a query received via service interface 206. Structured data refers generally to data where it is understood by a component or module accessing the data what that data means. For example, the component or module accessing the data can know the particular data refers to an address, a phone number, a movie title, and so forth, rather than simply being text.

It should be noted that data service 204 does not simply host Web pages (e.g., in a HyperText Markup Language (HTML)) that are returned in response to a request for the pages. Rather, data service 204 performs one or more operations on a query received via service interface 206 to look up, calculate, or otherwise obtain information related to the query received via service interface 206.

It should also be noted that an amount of time is taken by data service 204 to respond to a query. The amount of time taken by data service 204 to respond to a query can vary based on a variety of different factors, such as the particular query, the operations performed by operation modules 208, the number of other queries being responded to by data service 204, and so forth. The amount of time taken by data service 204 can exceed the amount of time that search service 202 is expected to take to respond to a user query. Accordingly, situations exist where it is not feasible for a user query to be received by search service 202 and simply forwarded on to data service 204 because the results from data service 204 would not be returned before search service 202 is to return its results.

Search service 202 includes a search engine module 210 (which can be, for example, search engine module 112 of FIG. 1) and a complex data set generation module 212 (which can be, for example, complex data set generation module 114 of FIG. 1). Complex data set generation module 212 submits potential user queries to data service 204 and stores or caches the data returned by data service 204 in complex data set store 214. When search engine module 210 subsequently receives the same user query, search engine module 210 obtains at least part of the results to be returned in response to the query from complex data set store 214.

A potential user query refers to a user query that may be, but is not necessarily, a query actually submitted by a user. Complex data set generation module 212 identifies a set of multiple queries that may potentially be submitted to search engine module 210 by a user. This set of multiple queries can be identified in different manners as discussed in more detail below. The queries in this set are the potential user queries submitted to data service 204 by complex data set generation module 212. It should be noted that the potential user queries are submitted to data service 204 independently of whether any such user queries are received by search engine module 210 from a user. The potential user queries can be submitted before receiving a user query from a user or after receiving a user query from a user, but need not be submitted in response to receiving a user query from a user.

Complex data set generation module 212 includes data search module 222 and temporary data store 224. Data search module 222 obtains or accesses the set of multiple queries that may potentially be submitted to search engine module 210 by a user and submits the queries in that set to data service 204. Module 222 submits a query to data service 204 by invoking service interface 206, which includes providing the query to service interface 206. Module 222 can submit queries to data service 204 from the set individually, or alternatively can submit two or more queries concurrently. Module 222 can select queries from the set to be submitted to data service 204 in a variety of different manners, such as least recently submitted queries being selected before more recently submitted queries, selecting queries randomly, selecting queries according to other rules or criteria, and so forth. Additionally, module 222 can submit queries to data service 204 at a variety of different regular or irregular intervals. It is to be appreciated that module 222 can submit the same potential user query to data service 204 multiple times (e.g., once per day, once every eight hours, etc.).

Data service 204 returns a set of data to data search module 222 in response to a query submitted by module 222. This set of data can include a variety of different types of data, such as text data, image data, audio data, video data, and so forth. The set of data returned by data service 204 is the search results, and includes one or more items that are related to the query that data service 204 receives. The particular manner in which the search results are determined by data service 204 can vary based on the operations performed by operation modules 208.

Data search module 222 stores the search results in complex data set store 214. The data can be stored in store 214 in a variety of different manners. In one of more embodiments, data is stored in complex data set store 214 indexed or keyed to the particular query in response to which the search results are received. Thus, module 222 stores in complex data set store 214 both the query that was submitted to data service 204 (if not already in store 214) and the search results received from data service 204 in response to that query. Data can be maintained in complex data set store 214 using an eXtensible Markup Language (XML) format or alternatively using one or more of a variety of other formats or data structures. For example, the search results returned by data service 204 can be stored in an XML document having a name that is (or is mapped to or otherwise associated with it) the particular query for which the search results are the response. Store 214 is referred to as a complex data set store due to the data that it stores and the format in which the data is stored.

Additionally, in one or more embodiments the search results received from data service 204 in response to a query includes one or more links to other data. This linked-to data can be maintained by data service 204 or alternatively another data source (e.g., another service or computing device). A link identifies a location where data is stored and can be, for example, a Uniform Resource Locator (URL). For example, the search results received from data service 204 may include text data and links to image data or audio data. When search results with a link are received by data search module 222, module 222 also retrieves the linked-to data and stores the linked-to data in complex data set store 214. For example, if search results received from data service 204 includes links to one or more images and links to one or more audio clips, module 222 retrieves the one or more images and one or more audio clips identified by the links and stores those one or more images and one or more audio clips in complex data set store 214.

It should be noted that in situations where linked-to data is retrieved, the data that is retrieved using a link may be in a format that cannot be readily stored in complex data set store 214. In such situations, data search module 222 converts the data that is retrieved using the link into a format that can be stored in complex data set store 214. For example, the linked-to data could be an image file. Data search module 222 retrieves the image file, obtains the image data from within that file, and stores the image data in complex data set store 214.

In one or more embodiments, the search results received from data service 204 in response to a query are stored in complex data set store 214 as associated with that query. If the query was previously submitted to data service 204 and search results in response to that previous submission are already stored in complex data set store 214, then module 222 replaces the previously received search results in complex data set store 214 with the newly received search results.

In other embodiments, data search module 222 uses temporary data store 224 to store copies of the search results returned by data service 204 in response to queries. One or more of the most recently returned search results for each query submitted by module 222 is maintained in temporary data store 224. For a particular query, module 222 compares the current search results from data service 204 to the search results received from data service 204 in response to a previous submission of that particular query (e.g., the most recent previous submission of that particular query). Module 222 uses this comparison to make an intelligent decision regarding storage of the search results received in the current response from data service 204.

Data search module 222 can make an intelligent decision regarding storage of the data received in the current response from data service 204 in a variety of different manners. In one or more embodiments, module 222 compares the number of items in the search results that are included in the current response from data service 204 to the number of items in the search results that were included in response to the previous submission of the particular query. If the number of items in the search results that were included in the response to the previous submission of the query is at least a threshold amount greater than the number of items in the search results that are included in the current response, then the search results received in the current response do not replace the search results already in complex data set store 214. This threshold amount can be a fixed amount (e.g., 100 items in the search results), or a variable amount (e.g., 10% of the number of items in the search results). Otherwise, the search results received in the current response do replace the search results already in complex data set store 214.

In other embodiments, module 222 makes an intelligent decision regarding storage of the search results received in the current response from data service 204 by comparing the individual items in the search results that are included in the current response to the individual items in the search results that were included in response to the previous submission of the particular query. Individual items in the search results that are included in the current response but were not included in response to the previous submission of the particular query are added to complex data set store 214.

In other embodiments, module 222 makes an intelligent decision regarding storage of the data received in the current response from data service 204 by identifying situations where the items in the search results that are included in the current response are different from the items in the search results that were included in the response to the previous submission of the particular query. When such a situation is identified, module 222 communicates a notification to another component, module, or individual (e.g., an administrator) of the presence of the situation. This other component, module, or individual can then notify module 222 of the action to be taken regarding storage of the search results received in the current response from data service 204.

Search engine module 210 includes a retrieval module 232 and a query normalization module 234. Retrieval module 232 receives a user query 236 from another device, such as a computing device 102 of FIG. 1. A user query 236 is typically received from a user of another device, but alternatively can be generated by another component or module rather than a user. Retrieval module 232 obtains search results based on user query 236, and returns the search results to the requester as query response 238. The requester is, for example, the computing device being used by the user, or another component or module.

In one or more embodiments, query normalization module 234 normalizes user query 236 to generate a normalized query. The normalized query is generated to represent the idea that is deemed to have been intended by user query 236. Query normalization module 234 stores a mapping of user query 236 to the normalized query as query map 240. Multiple different user queries 236 can map to the same normalized query. This allows multiple different versions of what is deemed to be the same intended idea being mapped to the same normalized query.

For example, a user may desire to know the population of France, and can specify a query to obtain this information in a variety of different manners. For example, the user may input as user query 236 the query “population of France”, “what is France's population”, “how many people live in France”, and so forth. The user may also input a user query 236 with a typographical error, such as “population of Franec”. Query normalization module 234 deems these different user queries as being the same intended idea and thus maps these different user queries to the same normalized query.

Query normalization module 234 can determine which different user queries are deemed as being the same intended idea in a variety of different manners. In one or more embodiments, query normalization module 234 accesses a collection of multiple previously entered user queries. This collection of previously entered user queries can be user queries previously submitted to retrieval module 232 or alternatively can be user queries previously submitted to a different search engine module or component. Query normalization module 234 submits each of these previously entered user queries to data service 204 via service interface 206, and compares the items in the search results returned by data service 204 for these queries. If the items in the search results returned by data service 204 for two different queries match, then those two different queries are deemed by query normalization module 234 as being the same intended idea.

Whether the items in the search results returned by data service 204 for two different queries match can be determined in a variety of different manners. In one or more embodiments, the items in the search results returned by data service 204 for two different queries match if the items in the search results returned by data service 204 for the two different queries are the same (e.g., identical items in the search results are returned). In other embodiments, the items in the search results returned by data service 204 for two different queries match if at least a threshold number of the items in the search results are the same (e.g., identical). This threshold number can be a fixed number (e.g., at least 1000 items in the search results), or alternatively can be a variable number (e.g., at least 10% of the items in the search results).

In addition to, or alternatively in place of, determining which different user queries are deemed as being the same intended idea based on a collection of multiple previously entered user queries, query normalization module 234 employs a technique of changing user queries. Query normalization module 234 obtains a user query, which can be a previously submitted query or a user query 236. The user query is submitted to data service 204 via service interface 206 and the results returned by data service 204 are maintained at least temporarily. Query normalization module 234 changes that user query in one or more of a variety of different manners. For example, query normalization module 234 can rearrange the order of words in the user query, remove one or more words from the user query, add one or more words to user query, and so forth. Query normalization module 234 can be configured with or otherwise obtain an indication of the manner in which the user query is to be changed.

Query normalization module 234 submits each of these changed user queries to data service 204 via service interface 206, and compares the items in the search results returned by data service 204 for these changed queries to the original (unchanged) user query. For each of the changed user queries, if the items in the search results returned by data service 204 for that changed user query matches the original user query, then that changed user query and the original user query are deemed by query normalization module 234 as being the same intended idea. Whether the items in the search results returned by data service 204 for two different queries match can be determined in a variety of different manners as discussed above.

For multiple different user queries that are deemed as being the same intended idea, one of those multiple different user queries is selected as the normalized query, and a mapping of the other of the multiple different user queries to the normalized query is maintained in query map 240. The one of the multiple different user queries that is the normalized query can be selected in a variety of different manners. For example, a first of the multiple different user queries encountered by query normalization module 234, or submitted to data service 204, can be selected as the normalized query. By way of another example, the normalized query can be selected randomly from the multiple different queries, can be selected as the one of the multiple different queries having the smallest number of words or characters, can be selected according to other rules or criteria, and so forth.

Complex data set store 214 stores the search results returned by data service 204 in response to potential user queries submitted to data service 204 via service interface 206. In one or more embodiments, these potential user queries are the normalized queries generated by query normalization module 234. Accordingly, in response to user query 236, retrieval module 232 accesses query normalization module 234. Query normalization module 234 obtains a normalized query for the user query 236 based on query map 240. Query normalization module 234 provides the normalized query to retrieval module 232, which in turn accesses complex data set store 214.

Complex data set store 214 is keyed or indexed based on the queries as discussed above. Accordingly, the search results previously obtained from data service 204 can be readily obtained from store 214 by looking up the data in store 214 that is associated with the normalized query. The search results from store 214 are returned by retrieval module 232 to the requester as query response 238.

Thus, complex data set store 214 need not maintain the search results from data service 204 for multiple different user queries that are deemed as being the same intended idea. For example, complex data set store 214 can maintain the search results for the user query “population of France”, but not for the user queries “what is France's population” and “how many people live in France”. Rather, query normalization module 234 is relied on as mapping the user queries “what is France's population” and “how many people live in France” to the user query “population of France”, so that the user query “population of France” is used to retrieve data from complex data set store 214 even though user query 236 may be “what is France's population” or “how many people live in France”.

In addition to returning search results from complex data set store 214 as query response 238, other search results can also be obtained by retrieval module 232 and returned as part of query response 238. For example, HTML Web pages can be searched by retrieval module 232 in a variety of different known manners, and those results can be returned as part of query response 238. The search results from complex data set store 214 can be returned with an indication that they are separate from other search results obtained by retrieval module 232, allowing the search results from complex data set store 214 to be displayed or otherwise presented to a user separately from (e.g., in a different portion of a window, with a different heading, etc.) than other search results obtained by retrieval module 232.

Alternatively, retrieval module 232 can combine the search results from complex data set store 214 with other search results that retrieval module 232 obtains, and return the combined search results as query response 238. Retrieval module 232 can, but need not, return as part of query response 238 an indication of the different sources of the different parts of query response 238. Retrieval module 232 can combine the search results from complex data set store 214 with other search results that retrieval module 232 obtains in a variety of different manners. For example, the search results can be ranked by order of perceived importance (e.g., ranked by data service 204, ranked by different techniques used in obtaining search results from other sources (e.g., ranking of HTML Web pages), and so forth). The search results from complex data set store 214 and the other search results obtained by retrieval module 232 are combined according to these rankings, with higher ranking results being listed before lower ranking results regardless of the sources of the results.

It should be noted that situations can arise where there is no mapping in query map 240 for a particular user query 236. Query normalization module 234 can respond to such situations in a variety of different manners, such as returning user query 236 to retrieval module 232 as the normalized query.

It should also be noted that situations can arise where search results for a particular normalized query are not included in complex data set store 214. Retrieval module 232 can respond to such situations in a variety of different matters. For example, retrieval module 232 can return an indication that the search results for user query 236 are not currently available. By way of another example, retrieval module 232 can return an indication that search results for user query 236 will be delayed slightly, and then submit user query 236 to data service 204 via service interface 206. The search results received from data service 204 are received by retrieval module 232, which then returns those search results to the requester as query response 238.

It should further be noted that query normalization module 234 can alternatively use any one or more of a variety of other different techniques for determining which different user queries are deemed as being the same intended idea. For example, query normalization module 234 can use any one or more of a variety of different statistical analysis techniques to determine which different user queries are deemed as being the same intended idea. By way of another example, query normalization module 234 can use any one or more of a variety of different natural language processing techniques to understand the patterns of the user queries and determine which different user queries are deemed as being the same intended idea.

Alternatively, in one or more other embodiments normalized queries need not be generated. Rather, data for each user query 236 is maintained in complex data set store 214, and no mapping of a user query 236 to a normalized query is performed. It is to be appreciated that in such embodiments search service 202 need not include query normalization module 234 and query map 240.

As discussed above, complex data set generation module 212 identifies a set of multiple queries that may potentially be submitted to search engine module 210 user. This set of multiple queries can be identified by data search module 222 in a variety of different matters. In one or more embodiments, data search module 222 identifies the set of multiple queries as the normalized queries in query map 240. Alternatively, data search module 222 can identify the set of multiple queries in other manners, such as obtaining a set of multiple queries from a different component module, identifying the queries used as the keys or indexes in complex data set store 214 as a set of multiple queries, and so forth.

Queries that are used as keys or indexes in complex data set store 214 can be added to complex data set store 214 in a variety of different manners. For example, data search module 222 can add the query and associated search results to complex data set store 214 after the search results received in response to submitting the query to data service 204 via service interface 206 are received from data service 204. By way of another example, query normalization module 234 can generate normalized queries as discussed above and add those normalized queries to complex data set store 214. Data search module 222 can access store 214 to identify those queries, submit those queries to data service 204 via service interface 206, and store the search results received in response to submitting those queries to data service 204 via service interface 206 as the search results associated with those queries.

It should also be noted that although a single data service 204 is illustrated in FIG. 2, data search module 222 can submit potential user queries to multiple data services. The search results received from these different data services in response to the same potential user query are stored by data search module 222 in complex data set store 214. Data search module 222 can make intelligent decisions regarding storage of data received from each of these different data services in response to the same potential user query as discussed above. For example, the same XML document can be used to store search results for the same potential user query from different data services. The query response 238 returned to the requester can thus include search results received from multiple different data services.

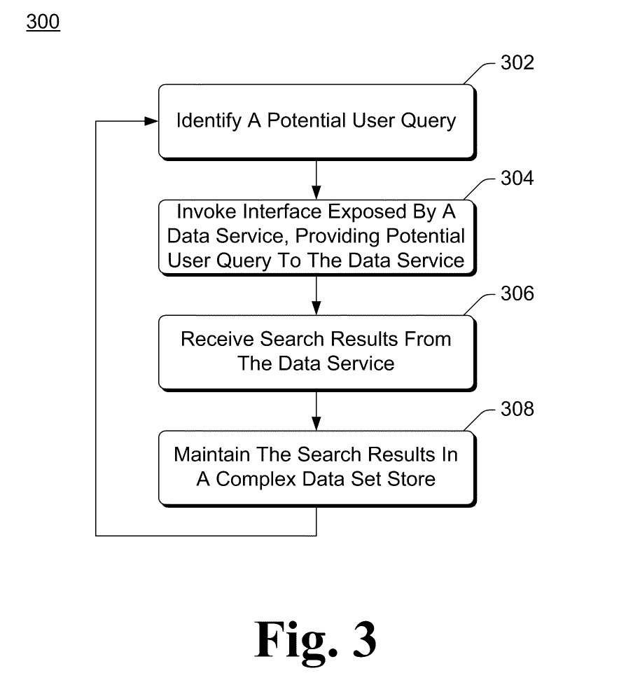

FIG. 3 is a flowchart illustrating an example process 300 for caching data obtained via data service interfaces in accordance with one or more embodiments. Process 300 is carried out by a complex data set generation module, such as module 212 of FIG. 2, and can be implemented in software, firmware, hardware, or combinations thereof. Process 300 is shown as a set of acts and is not limited to the order shown for performing the operations of the various acts. Process 300 is an example process for caching data obtained via data service interfaces; additional discussions of caching data obtained via data service interfaces are included herein with reference to different figures.

In process 300, a potential user query is identified (act 302). This potential user query can be identified in a variety of different manners as discussed above.

An interface exposed by a data service is invoked (act 304). As part of invoking the interface, the potential user query identified in act 302 is provided to the data service.

Search results are received from the data service (act 306) in response to the interface of the data service being invoked in act 304. The search results can include numerous items as discussed above.

The search results are maintained in a complex data set store (act 308). The search results can optionally be stored in the complex data set store based on an intelligent decision regarding storage of the data as discussed above. The search results are stored keyed or indexed to the potential user query identified in act 302 as discussed above.

Process 300 then returns to act 302 to identify another potential user query. Process 300 is thus repeated for multiple different potential user queries, and can also be repeated for the same potential user query as discussed above.

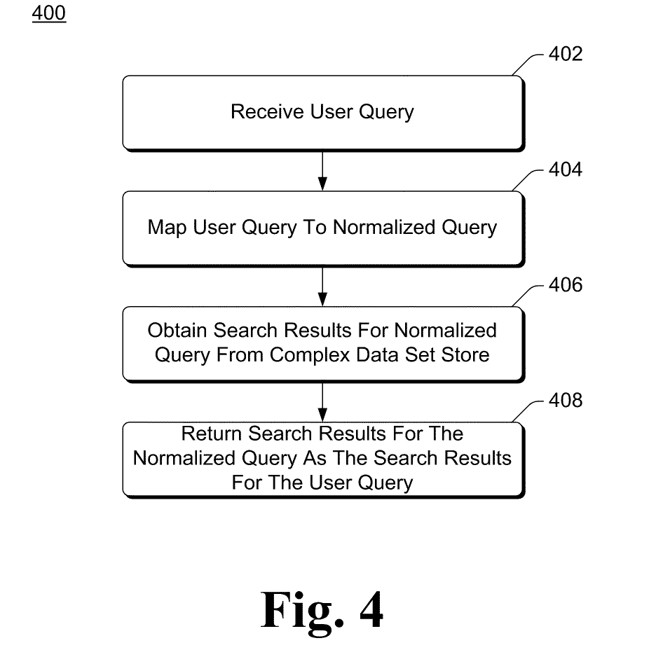

FIG. 4 is a flowchart illustrating an example process 400 for retrieving previously cached data in response to a user query in accordance with one or more embodiments. Process 400 is carried out by a search engine module, such as module 210 of FIG. 2, and can be implemented in software, firmware, hardware, or combinations thereof. Process 400 is shown as a set of acts and is not limited to the order shown for performing the operations of the various acts. Process 400 is an example process for caching data obtained via data service interfaces; additional discussions of caching data obtained via data service interfaces are included herein with reference to different figures.

In process 400, a user query is received (act 402). The user query can be received from a variety of different devices, components, or modules as discussed above.

The user query received in act 402 is mapped to a normalized query (act 404). The normalized query to which the user query is mapped can be generated in a variety of different manners as discussed above.

Search results for the normalized query are obtained from a complex data set store (act 406). These search results were previously obtained from one or more data services and stored in complex data set store as discussed above. As discussed above, these search results can include one or more of text data, image data, audio data, video data, and so forth.

The search results obtained from the complex data set store are returned as the search results for the received user query (act 408). Thus, in response to the user query received in act 402, search results obtained from the complex data set store are returned to the requester. As discussed above, the search results can optionally be combined with search results obtained in other manners.

Process 400 can be repeated one or more times for additional user queries.

The caching data obtained via data service interfaces discussed herein supports a variety of different usage scenarios. For example, a particular data service may offer movie or song recommendations in response to a user query, such as a request for a movie or song similar to a movie or song identified in the query. The search service can submit this query to the data service and cache the received search results in its complex data set store. When a user subsequently submits that same query, the search service returns its response with the results stored in the complex data set store rather than needing to resubmit the query to the data service.

By way of another example, a particular data service may offer information regarding particular dates in history in response to a user query identifying a particular date. This information can include images, historical facts, popular songs, and so forth. The search service can submit a query for a particular date to the data service and cache the received search results in its complex data set store. The cached search results include the images, historical facts, popular songs, and so forth identified by the data service as being associated with that particular date. When a user subsequent submits a user query to the search service for information regarding that particular date, the search results for that particular date that are cached in the complex data set store are returned in response to the query.

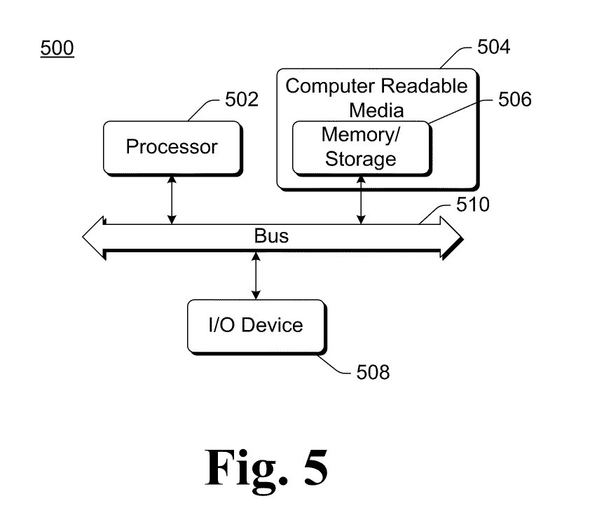

FIG. 5 illustrates an example computing device 500 that can be configured to implement the caching data obtained via data service interfaces in accordance with one or more embodiments. Computing device 500 can be, for example, a computing device 102 of FIG. 1, or can be a computing device implementing at least part of a data service 104 or search service 110 of FIG. 1, or search service 202 or data service 204 of FIG. 2.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the caching data obtained via data service interfaces techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
identifying a potential user query that can be subsequently received from a requester;
invoking an interface exposed by a data service, the invoking including providing the potential user query to the interface;
receiving, from the interface, search results in response to the potential user query; and
maintaining the search results in a complex data set store from which the search results can be returned to the requester if the potential user query is subsequently received from the requester.

2. A method as recited in claim 1, wherein the potential user query is a normalized query that maps to multiple different user queries, and wherein maintaining the search results comprises maintaining the search results in the complex data set store from which the search results can be returned to the requester if one of the multiple different user queries that maps to the normalized query is subsequently received from the requester.

3. A method as recited in claim 1, wherein maintaining the search results comprises:
determining, based at least in part on previous search results received in response to previously invoking the interface including previously providing the potential user query to the interface, whether to replace the previous search results in the complex data set store with the search results received in response to the potential user query; and
storing the search results received in response to the potential user query in the complex data set store only if it is determined that the previous search results in the complex data set store are to be replaced with the search results received in response to the potential user query.

4. A method as recited in claim 3, wherein the determining is based at least in part on whether a number of items in the previous search results received in response to previously invoking the interface is at least a threshold amount greater than a number of items in the search results received in response to the potential user query.

5. A method as recited in claim 1, wherein identifying the potential user query comprises identifying the potential user query based at least in part on a collection of multiple previously entered user queries.

6. A method as recited in claim 1, wherein maintaining the search results comprises storing the search results in the complex data set store indexed by the potential user query.

7. A method as recited in claim 6, wherein maintaining the search results further comprises identifying one or more links in the search results, and for each of the one or more links:
retrieving linked-to data from a location identified by the link; and
storing the linked-to data in the complex data set store as part of the search results.

8. A method as recited in claim 1, wherein the identifying, invoking, receiving, and maintaining is performed independently of whether the potential user query is subsequently received from the requester.

9. A method as recited in claim 1, wherein the interface comprises an application programming interface.

10. A method as recited in claim 1, further comprising:
invoking an additional interface exposed by an additional data service, the invoking the additional interface including providing the potential user query to the additional interface;
receiving, from the additional interface, additional search results in response to the potential user query; and
maintaining the additional search results as part of the search results in the complex data set store.

11. A method as recited in claim 1, further comprising, after the identifying, invoking, receiving, and maintaining:
receiving a user query from the requester;
mapping the user query to a normalized query that is the potential user query;
obtaining, from the complex data set store, the search results for the normalized query; and
returning, to the requester, the search results for the normalized query as the search results for the user query.

12. A method as recited in claim 11, wherein identifying the potential user query comprises obtaining, as the potential user query, one of multiple normalized queries to which user queries can be mapped.

13. A method comprising:
receiving a user query;
mapping the user query to a normalized query;
obtaining, from a complex data set store, search results for the normalized query, wherein the search results are in the complex data set store as a result of the normalized query having been submitted, prior to receiving the user query, to an interface of a data service; and
returning, from the complex data set store, the search results for the normalized query as the search results for the user query.

14. A method as recited in claim 13, wherein the complex data store stores search results for multiple different normalized queries indexed to the multiple different normalized queries.

15. A method as recited in claim 14, wherein the search results include two or more of text data, image data, audio data, and video data.

16. A method as recited in claim 13, wherein the complex data set store includes as the search results both data received from the data service and additional data received from an additional data source.

17. A method as recited in claim 13, further comprising combining the search results with additional search results obtained from searching HyperText Markup Language (HTML) Web pages, and returning the search results from the complex data set store combined with the additional search results obtained from searching HTML Web pages as the search results for the user query.

18. A method as recited in claim 13, wherein the search results are stored in the complex data set store indexed by normalized user queries, and wherein obtaining the search results comprises obtaining search results indexed to the normalized query.

19. A method as recited in claim 18, wherein obtaining search results indexed to the normalized query comprises obtaining an eXtensible Markup Language (XML) document that stores the search results and is associated with the normalized query.

20. A search service comprising:
a complex data set generation module configured to:
identify a potential user query that can be subsequently received from a requester,
invoke an interface exposed by a data service, wherein to invoke the interface is to provide the potential user query to the interface,
receive, from the interface, search results in response to the potential user query, and
maintain the search results in a complex data set store from which the search results can be returned to the requester if the potential user query is subsequently received from the requester; and
a search engine module configured to:
receive a user query from the requester,
map the user query to a normalized query that is the potential user query,
obtain, from the complex data set store, the search results for the normalized query, and
return, to the requester, the search results for the normalized query as the search results for the user query.
